(19) United States
(12) Patent Application Publication
(10) Pub. No.: US 2010/0320787 A1
(43) Pub. Date: Dec. 23, 2010

(54) LIFTING DEVICE

(76) Inventor: Hayrettin Dilsiz, Berlin (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/449,715

(22) PCT Filed: Feb. 15, 2008
(86) PCT No.: PCT/DE2008/000308

§ 371 Date: Sep. 17, 2009

(30) Foreign Application Priority Data
Feb. 22, 2007 (DE) 102007008603.4

(51) Int. Cl. B66C 1/66; B66C 1/42; B66C 1/44

(52) U.S. Cl. 294/89

(57) ABSTRACT

A lifting device for lifting a workpiece provided with a scissor-type linkage having two arms and two rod-like gripping arms connected thereto in an articulated manner. The lifting device also includes a cross member having at least two axially adjacent elongated holes extending in the axial direction of the cross member. The two gripping arms are each guided through an associated elongated hole and are rotatable around an axis extending transverse to the longitudinal direction and transverse to the through-direction of the associated elongated hole and it becomes. As a result, it becomes possible for the free ends of the gripping arms to tilt in an associated lifting opening of the workpiece, i.e., a cylinder head, when a workpiece is lifted.

The invention is directed to a lifting device for lifting a workpiece according to the preamble of claim 1.

A generic lifting device is known, for example, from DE 20 2005 007 464 U1. This lifting device has two arms forming pincers, each arm comprising a lifting arm and a gripping arm with a gripping element at its free end. Each arm of the pincers is pivotably mounted between the lifting arm and the gripping arm for opening and closing the pincers. Further, the lifting device has a cross member to which the two arms of the pincers are pivotably connected at a distance from one another, and each of the lifting arms has one or more points of application for connecting nonrigid pulling means.

Other lifting devices are known, for example, from DE 39 07 200 C1, JP 09124267 A, and DD 251 721 A1.

In the known lifting devices, it is often problematic to correctly position the lifting devices in relation to the workpiece to be lifted so as to ensure a secure lifting. However, particularly in industrial manufacturing, it is required that the lifting devices can grip the workpiece to be lifted and be connected to it quickly and reliably at the same time.

The invention addresses the problem of providing an improved embodiment form, or at least a different embodiment form, for a generic lifting device which makes it possible to lift a workpiece quickly and securely at the same time.

According to the invention, this problem is solved through the subject matter of the independent claim 1. Advantageous embodiment forms are the subject matter of the dependent claims.

The invention is based on the general idea of constructing a lifting device, particularly for lifting cylinder heads, by means of a scissor-type linkage with two gripping arms supported at the latter in an articulated manner and with a cross member such that the two gripping arms of the lifting device can be inserted in a simple manner into associated cylinder head bores, and a tilting of the two gripping arms takes place in the cylinder head bores during the lifting process of the lifting device owing to the scissor mechanism in such a way that the cylinder head can be lifted reliably and securely. To this end, the lifting device comprises the above-described scissor-type linkage having two arms, and the two rod-like gripping arms, and a cross member which has at least two axially adjacent elongated holes extending in axial direction of the cross member. The two gripping arms are each guided through one of the two elongated holes and have a fixing element for the purpose of preventing them from being pulled out of the associated elongated hole unintentionally during the lifting process of the lifting device. During the lifting process of the lifting device, the scissor-type linkage causes a rotation of the two gripping arms around an axis extending transverse to the longitudinal direction of the associated elongated hole and transverse to the through-direction of the associated elongated hole so that the free ends of the gripping arms tilt in the associated lifting openings of the workpiece, in particular in the cylinder head bores, and accordingly make it possible for the latter to be lifted.

Each free end of the gripping arm advisably has an anti-slip coating. In this respect, it is conceivable that an anti-slip coating of this kind, particularly a plastic or rubber coating, protects the cylinder head bores during the insertion of the rod-like gripping arms on the one hand and, on the other hand, prevents the tilted gripping arms from being pulled out of the lifting openings when the workpiece is lifted or at least makes it more difficult for this to happen.

In another advantageous construction of the solution according to the invention, a stop element is provided at each gripping arm in the area of the elongated hole, which stop element defines a depth to which the free end of the gripping arm can be inserted into the associated lifting opening on the one hand and, on the other hand, protects an entry area of the lifting openings from damage during the lifting process. The stop element can be constructed, for example, as a typical plastic element, particularly a rubber element, and can be dimensioned in such a way that its diameter is greater than the diameter of the associated lifting opening.

Other important features and advantages of the invention are indicated in the subclaims, the drawing, and the accompanying description of the drawing.

Of course, the features mentioned above and described in more detail in the following are usable not only in the combinations indicated herein but also in other combinations or individually without departing from the framework of the present invention.

A preferred embodiment example of the invention is shown in the drawing and is described in more detail in the following description.

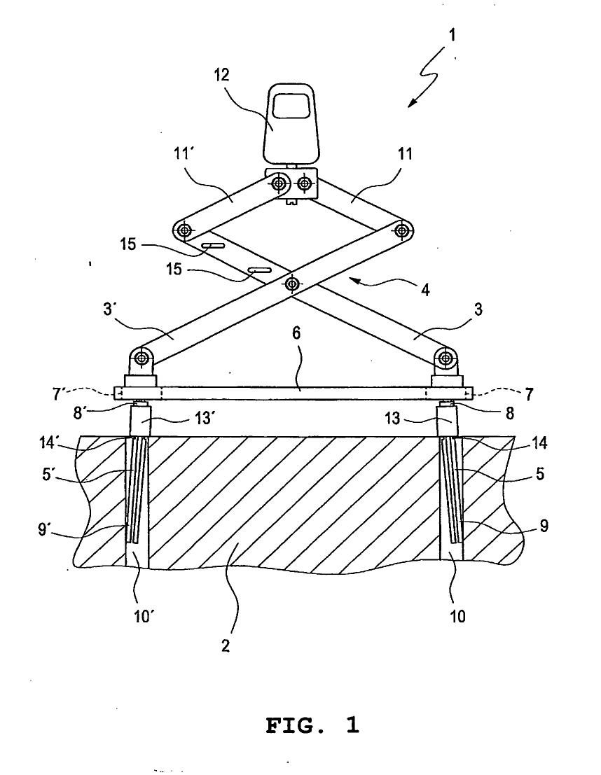

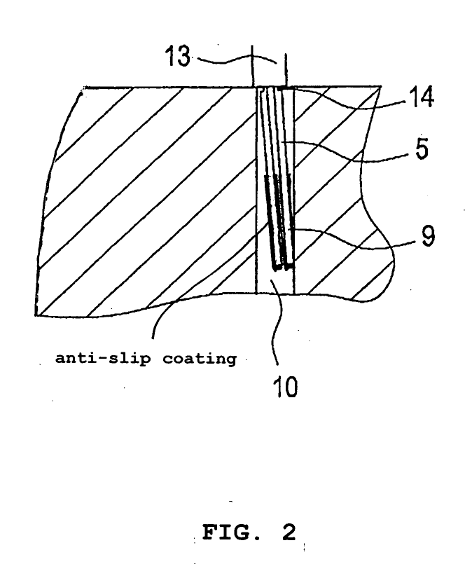

The sole drawing, FIG. 1, shows a lifting device according to the invention.

Corresponding to FIG. 1, a lifting device 1 according to the invention for lifting a workpiece 2, particularly for lifting a cylinder head, has a scissor-type linkage 4 having two arms 3 and 3′ and two rod-like gripping arms 5 and 5′ which are connected thereto in an articulated manner. Further, the lifting device 1 comprises a cross member 6 which has at least two axially adjacent elongated holes 7 and 7′ extending in axial direction of the cross member 6. The elongated holes 7 and 7′ are arranged, respectively, in the area of a longitudinal end of the cross member 6. The two gripping arms 5 and 5′ are guided through the respective associated elongated hole 7, 7′ and have a fixing element 8 and 8′, respectively, to prevent the gripping arms 5 and 5′ from being pulled out of the associated elongated hole 7, 7′ unintentionally. The fixing elements 8, 8′ prevent the cross member 6 from falling down during the lifting process of the lifting device 1.

According to FIG. 1, each of the two gripping arms 5, 5′ is rotatable around an axis which extends transverse to the longitudinal direction and transverse to the through-direction of the associated elongated hole 7, 7′ and which extends substantially perpendicular to the drawing plane referring to the drawing in FIG. 1 and in this way makes possible a tilting of the free gripping arm ends 9, 9′ in an associated lifting opening 10, 10′ of the workpiece 2 when the latter is lifted.

At their end remote of the respective gripping arm 5, 5′, the two arms 3 and 3′ are respectively connected in an articulated manner to a strut 11, 11′, respectively, preferably a push/pull strut, these struts 11, 11′ being supported in an articulated manner at their other respective end at a common holding element 12. The lifting device 1 can be fastened to a crane hook, for example, by the holding element 12. The struts 11, 11′ are connected to the holding element 12 in such a way that the weight of the scissor-type linkage 4 and of the workpiece 2 held at the latter acts symmetrically on the holding element 12. As can be seen from FIG. 1, strut 11′ is fastened to the holding element 12 in the front in the viewing direction, while strut 11 is fastened to the holding element 12 in the back in the viewing direction.

In order to improve a tilting of the free gripping arm ends 9, 9′ in the respective associated lifting opening 10, 10′, an anti-slip coating, not shown, for example, a rubber or an elastic plastic, can be arranged in addition at each free gripping arm end 9, 9′.

The arm 3 is provided with two locking elements 15 which form a stop for the adjoining strut 11′ when the scissor-type linkage 4 folds together. The arms 3, 3′ are so dimensioned that the distance between the gripping arm ends 9, 9′ corresponds to the distance between the lifting openings 10, 10′ when the scissor-type linkage 4 folds together (i.e., when the strut 11′ stops against the locking element 15 of arm 3) so that the gripping arm ends 9, 9′ can be inserted easily into the lifting openings 10, 10′.

A stop element 13, 13′ is provided at each gripping arm 5, 5′ at its end remote of the free gripping arm end 9, 9′ in the area of the associated elongated hole 7, 7′. This stop element 13, 13′ defines an insertion depth of the free gripping arm end 9, 9′ in the associated lifting opening 10, 10′ on the one hand and prevents damage to an opening rim of the respective lifting opening 10, 10′ when the workpiece 2 is lifted by means of the lifting device 1 on the other hand. For this purpose, the stop element 13, 13′ can be made of elastic plastic, for example, particularly rubber. In an area adjacent to the stop element 13, 13′, the gripping arm end 9, 9′ is provided with a notch serving to prevent damage to the edges of the bore openings 10, 10′ on the workpiece 2 during lifting and/or transporting.

The articulated connections between the individual arms 3, 9 and 11 are produced by means of commercially available screw connections.

1.-4. (canceled)

5. A lifting device for lifting a workpiece, comprising:
a scissor-type linkage having two arms;
a plurality of rod-like gripping arms connected in an articulated manner to the scissor-type linkage;
a cross member having a plurality of axially adjacent elongated holes extending in an axial direction of the cross member;
wherein each of said plural rod-like gripping arms is guided through an associated elongated hole of the cross member and has a fixing element for preventing each of said plural rod-like gripping arms from being unintentionally removed from the associated elongated hole; and
wherein each of said plural rod-like gripping arms is rotatable around an axis extending transverse to a longitudinal direction and transverse to a through-direction of the associated elongated hole to enable a free end of each of said rod-like gripping arms to tilt in an associated lifting opening of the workpiece when said workpiece is lifted.

6. The lifting device according to claim 5, wherein the lifting opening of the workpiece is a bore in a cylinder head.

7. The lifting device according to claim 5, wherein each free end of each of said plural rod-like gripping arms has an anti-slip coating.

8. The lifting device according to claim 6, wherein each free end of each of said plural rod-like gripping arms has an anti-slip coating.

9. The lifting device according to claim 6, further comprising:
a stop element provided at each of said plural gripping arms in an area of the elongated hole, said stop element defining a depth to which the free end of each of said plural rod-like gripping arms is insertable into the associated lifting opening.

10. The lifting device according to claim 9, wherein the stop element is made of plastic.

11. The lifting device according to claim 6, further comprising:
a stop element provided at each of said plural gripping arms in an area of the elongated hole, said stop element defining a depth to which the free end of each of said plural rod-like gripping arms is insertable into the associated lifting opening.

12. The lifting device according to claim 7, further comprising:
a stop element provided at each of said plural gripping arms in an area of the elongated hole, said stop element defining a depth to which the free end of each of said plural rod-like gripping arms is insertable into the associated lifting opening.
